(19) United States
(12) Patent Application Publication
(10) Pub. No.: US 2026/0095050 A1
(43) Pub. Date: Apr. 2, 2026

(54) POWER SUPPLY SYSTEM

(71) Applicant: TOYOTA JIDOSHA KABUSHIKI KAISHA, Toyota-shi (JP)

(72) Inventors: Atsumi TSUZUKI, Toyota-shi (JP); Hironaga ONO, Toyota-shi (JP)

(73) Assignee: TOYOTA JIDOSHA KABUSHIKI KAISHA, Toyota-shi (JP)

(21) Appl. No.: 19/292,125

(22) Filed: Aug. 6, 2025

(30) Foreign Application Priority Data
Sep. 11, 2024 (JP) 2024-157603

(51) Int. Cl. H02J 3/32; G06Q 50/06; H02J 3/00; H02J 9/06

(52) U.S. Cl. CPC H02J 3/322; G06Q 50/06; H02J 3/0012; H02J 9/062; H02J 2105/12

(57) ABSTRACT

A power supply system includes a switch that electrically connects or disconnects a load corresponding to 100 V and a power conversion device to or from each other, and a switch that electrically connects or disconnects a load corresponding to 200 V and the power conversion device to or from each other. For supplying electric power from a vehicle to a load, a controller turns on or off each of the switches, based on a power supply capability of the vehicle and respective power demands of the loads.

### CROSS REFERENCE TO RELATED APPLICATIONS

This nonprovisional application is based on Japanese Patent Application No. 2024-157603 filed on Sep. 11, 2024 with the Japan Patent Office, the entire contents of which are hereby incorporated by reference.

### BACKGROUND

### Field

The present disclosure relates to a power supply system.

### Description of the Background Art

In a power supply system capable of supplying power from a system power supply to an electrical load of a house, power from a vehicle can be supplied to the electrical load mainly in an emergency (e.g., when a power failure of the system power supply occurs or when the system power supply is under power). In addition, it has been proposed to supply power from a vehicle to an electrical load on a daily basis (e.g., in a time period in which a system power supply has a high electricity fee). Japanese Patent Laying-Open No. 2019-71721 discloses a power supply system capable of utilizing electric power stored in an electrically powered vehicle at the time of a power failure.

### SUMMARY

The electrical load may include a first load operated by a first voltage and a second load operated by a second voltage, which, however, is not described explicitly in the above-referenced Japanese Patent Laying-Open No. 2019-71721. In this case, it is desired that power supplied from a vehicle is distributed appropriately to the first load and the second load.

The present disclosure is made for solving the above problem, and one object of the present disclosure is to provide a power supply system capable of appropriately distributing power supplied from a vehicle to loads associated with different voltages respectively.

A power supply system according to one aspect of the present disclosure is a power supply system that supplies AC power from a system power supply to an electrical load of a house, and includes: a current circuit breaker that receives AC power supplied from the system power supply to the house, and interrupts the AC power when at least one of electric leakage and overcurrent occurs; a load circuit breaker that electrically disconnects the current circuit breaker and the electrical load from each other; a power conversion device that supplies AC power from a vehicle to the electrical load when the vehicle is connected to the power conversion device; a switch that is capable of switching between electrical connection and disconnection between the load circuit breaker and the power conversion device; and a switching device that turns the switch on or off. The electrical load includes: a first load that is operated by a first voltage; and a second load that is operated by a second voltage different from the first voltage. The switch includes: a first switch capable of switching between electrical connection and disconnection between the first load and the power conversion device; and a second switch capable of switching between electrical connection and disconnection between the second load and the power conversion device. For supplying electric power from the vehicle to the electrical load, the switching device turns on or off each of the first switch and the second switch, based on a power supply capability of the vehicle, and a power demand of the first load and a power demand of the second load.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a circuit block diagram illustrating a configuration of a power supply system according to one embodiment.

FIG. 2 is a flowchart illustrating a first example of a process performed by a controller of the power supply system according to one embodiment.

FIG. 3 is a flowchart illustrating a second example of a process performed by a controller of the power supply system according to one embodiment.

FIG. 4 is a circuit block diagram illustrating a configuration of a power supply system according to a modification of one embodiment.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

### <System Configuration>

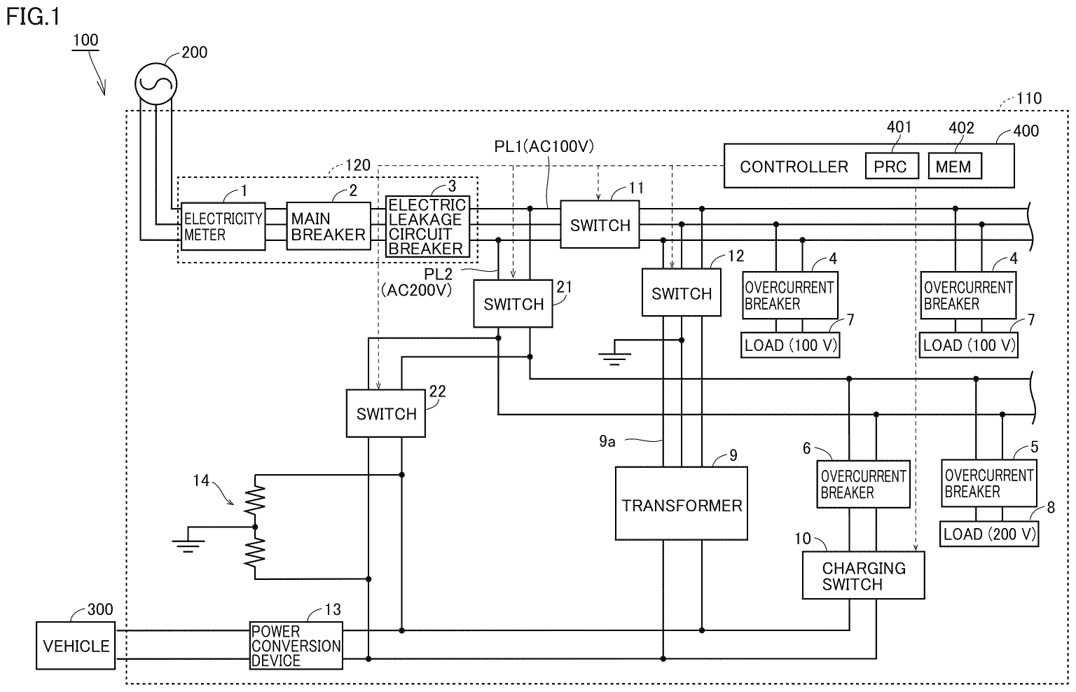

FIG. 1 is a circuit block diagram illustrating a configuration of a power supply system 100 according to the present embodiment. The power supply system 100 includes a house 110, a system power supply 200, and a vehicle 300. In the present embodiment, the system power supply 200 is capable of transmitting AC power of AC 100 V and AC power of AC 200 V. The vehicle 300 has an output voltage of 200 V at the time of power supply. Therefore, a power conversion device 13 (described later) connected to the vehicle 300 outputs AC power of AC 200 V. Note that 100 V and 200 V are examples of the “first voltage” and the “second voltage” in the present disclosure, respectively.

The power supply system 100 supplies power from the system power supply 200 to a load of the house 110. The house 110 is typically a house (a building in which a person resides). However, the house 110 may include buildings that are not residential, e.g., buildings, buildings housing equipment, etc. The load is, for example, various electric devices, and may be disposed inside (indoor) or outside (outdoor) the house 110.

The power supply system 100 includes an electricity meter 1, a main breaker 2, an electric leakage circuit breaker 3, overcurrent breakers (load circuit breakers) 4 and 5, an overcurrent breaker 6, a load (electrical load) (first load) 7, a load (electrical load) (second load) 8, a transformer (transformer) 9, a charging switch 10, a switch 11, a switch (switch) (first switch) 12, a switch 21, a switch (switch) (second switch) 22, a power conversion device 13, and a resistance element 14, a controller (switching device) 400 is provided. The number of overcurrent breakers is not particularly limited. Each of the switch 12 and the switch 22 is an example of a “switch” in the present disclosure. The switch 12 and the switch 22 are examples of the “first switch” and the “second switch” in the present disclosure, respectively. The controller 400 is an example of the “switching device” in the present disclosure. Each of the load 7 and the load 8 is an example of the “electrical load” in the present disclosure. The load 7 and the load 8 are examples of the “first load” and the “second load” in the present disclosure, respectively. Each of the overcurrent breaker 4 and the overcurrent breaker 5 is an example of the “load circuit breaker” of the present disclosure. The transformer 9 is an example of a “transformer” in the present disclosure.

The electricity meter 1 receives AC power from the system power supply 200 to the house 110. The main breaker 2 cuts off the electric path when an abnormality (overcurrent) is detected in the current capacity flowing from the system power supply 200. The electric leakage circuit breaker 3 cuts off the electric path when an electric leakage is detected. The electricity meter 1, the main breaker 2, and the electric leakage circuit breaker 3 constitute a current circuit breaker 120.

An electric path PL1 for transmitting AC 100V AC power and an electric path PL2 for transmitting AC 200V AC power are connected to the current circuit breaker 120.

The overcurrent breaker 4 is electrically connected to the AC 100V electric path PL1. Although not shown, the house 110 includes a plurality of rooms. Each of the plurality of rooms is provided with a load 7 for 100 V. Each of the plurality of rooms is provided with an overcurrent breaker 4. The overcurrent breaker 4 is configured to electrically disconnect the current circuit breaker 120 from the load 7 when overcurrent is detected. The overcurrent breaker 4 corresponds to a “load circuit breaker” according to the present disclosure. The load 7 corresponds to the “electrical load” according to the present disclosure.

The overcurrent breaker 5 is electrically connected to the AC 200V electric path PL2. Like the overcurrent breaker 4 for AC 100V, the overcurrent breaker 5 is provided in each of a plurality of rooms of the house 110. The overcurrent breaker 5 is configured to electrically disconnect the current circuit breaker 120 from the 200V load 8 when overcurrent is detected. In FIG. 1, only one load 8 (overcurrent breaker 5) is illustrated for simplification.

The power conversion device 13 is configured to be connected to the vehicle 300 via a power supply cable (not shown). The vehicle 300 is an electrically powered vehicle on which a running battery is mounted and which is capable of exchanging electric power with the outside of the vehicle. Specifically, the vehicle 300 is a BEV (Battery Electric Vehicle) or PHEV (Plug-in Hybrid Electric Vehicle). The power conversion device 13 includes an AC/DC conversion device. The power conversion device 13 is configured to supply AC power from the vehicle 300 to the loads 7 and 8 when the vehicle 300 is connected.

A first end of the switch 11 is electrically connected to the current circuit breaker 120. The second end of the switch 11 is electrically connected to the overcurrent breaker 4. Thus, the switch 11 is configured to switch between electrical connection and disconnection between the current circuit breaker 120 and the overcurrent breaker 4 (load 7) in accordance with a control command from the controller 400.

A first end of the switch 21 is electrically connected to the current circuit breaker 120. The second end of the switch 21 is electrically connected to the overcurrent breaker 5. Thus, the switch 21 is configured to switch between electrical connection and disconnection between the current circuit breaker 120 and the overcurrent breaker 5 (load 8) in accordance with a control command from the controller 400.

The transformer 9 is disposed in a current path 9a between the power conversion device 13 and the switch 12. A first end of the switch 12 is electrically connected to a first end of the transformer 9. The second end of the transformer 9 is electrically connected to the power conversion device 13. The second end of the switch 12 is electrically connected to the overcurrent breaker 4. Thus, the switch 12 is configured to switch between electrical connection and disconnection between the transformer 9 (power conversion device 13) and the overcurrent breaker 4 (load 7) in accordance with a control command from the controller 400. The transformer 9 converts AC 200V AC power transmitted from the power conversion device 13 into AC 100V AC power.

Accordingly, when power is supplied from the vehicle 300, the output voltage of the vehicle 300 can be adjusted to the voltage (100 V) corresponding to the load 7 by the transformer 9. As a result, power can be easily supplied from the vehicle 300 to the load 7.

In general, since large household appliances such as a water heater and air conditioning are included in the load 8 (200V load), the power demand (power consumption) of the load 7 (100V load) is often smaller than that of the load 8.

Therefore, the capacity of the transformer 9 can be made relatively small by arranging the transformer 9 on the current path 9a between the switch 12 on the load 7 side where the power demand is relatively small and the power conversion device 13.

A first end of the switch 22 is electrically connected to the power conversion device 13. The second end of the switch 22 is electrically connected to the overcurrent breaker 5. Accordingly, the switch 22 is configured to switch between electrical connection and disconnection between the power conversion device 13 and the overcurrent breaker 5 (load 8) in accordance with a control command from the controller 400.

The resistance element 14 is a high resistance element. The resistance element 14 is electrically connected to an electric path connecting the switch 22 and the power conversion device 13.

A first end of the charging switch 10 is electrically connected to the power conversion device 13. The second end of the charging switch 10 is electrically connected to the first end of the overcurrent breaker 6. The second end of the overcurrent breaker 6 is electrically connected to the second end of the switch 21. Thus, the vehicle 300 can be charged with electric power supplied from the system power supply 200 through the charging switch 10.

Although not shown, the current circuit breaker 120 and the overcurrent breakers 4, 5, and 6 are provided on a distribution board (depending on the type of the house 110, a distribution board may be used.). If the distribution board has a large size, the switches 11, 12, 21, and 22 and the charging switch 10 may be disposed inside the distribution board. In the case of a distribution board having a small size, the switches 11, 12, 21, and 22 and the charging switch 10 may be disposed in a housing externally attached to the distribution board and provided near the distribution board.

The controller 400 is a computer device including a processor 401 and a memory 402. The controller 400 is, for example, a HEMS (Home Energy Management System) controller. The controller 400 outputs a control command for opening and closing (switching on and off) each of the switches 11, 12, 21, and 22 and the charging switch 10. As described later, the controller 400 acquires power information (power transaction information, electricity fee information, and the like) of the system power supply 200 from an energy management server (not shown). The controller 400 may be capable of opening and closing the switches 11, 12, 21, and 22 or controlling the power conversion device 13 (that is, power is supplied from the vehicle 300) in accordance with the acquired power information.

AC power supplied from system power supply 200 and AC power supplied from vehicle 300 have different phases. Therefore, it is not preferable to simultaneously supply AC power from the system power supply 200 and AC power from the vehicle 300 to the loads 7 and 8. Which of the two AC powers is supplied to the loads 7 and 8 can be selected by using the switches 11 and 21 and the switches 12 and 22. Specifically, by turning on the switches 11 and 21, power can be supplied to the loads 7 and 8 using the power of the system power supply 200. By turning on the switches 12 and 22, power can be supplied to the loads 7 and 8 by using the power of the vehicle 300.

When power is supplied using the power of the system power supply 200, power can be supplied to the load 7 by turning on the switch 11, and power can be supplied to the load 8 by turning on the switch 21.

When power is supplied using power of the vehicle 300, power can be supplied to the load 7 by turning on the switch 12, and power can be supplied to the load 8 by turning on the switch 22.

Here, when power is supplied to each load using power of the vehicle 300, it is desired to appropriately distribute power supplied from the vehicle to each load.

Therefore, in the present embodiment, when power is supplied from the vehicle 300 to the loads 7 and 8, the controller 400 executes a switching process of switching on or off each of the switch 12 and the switch 22 based on the power supply capability of the vehicle 300 and the power demand of the load 7 and the power demand of the load 8. Details will be described along the flow below.

### <Process Flow>

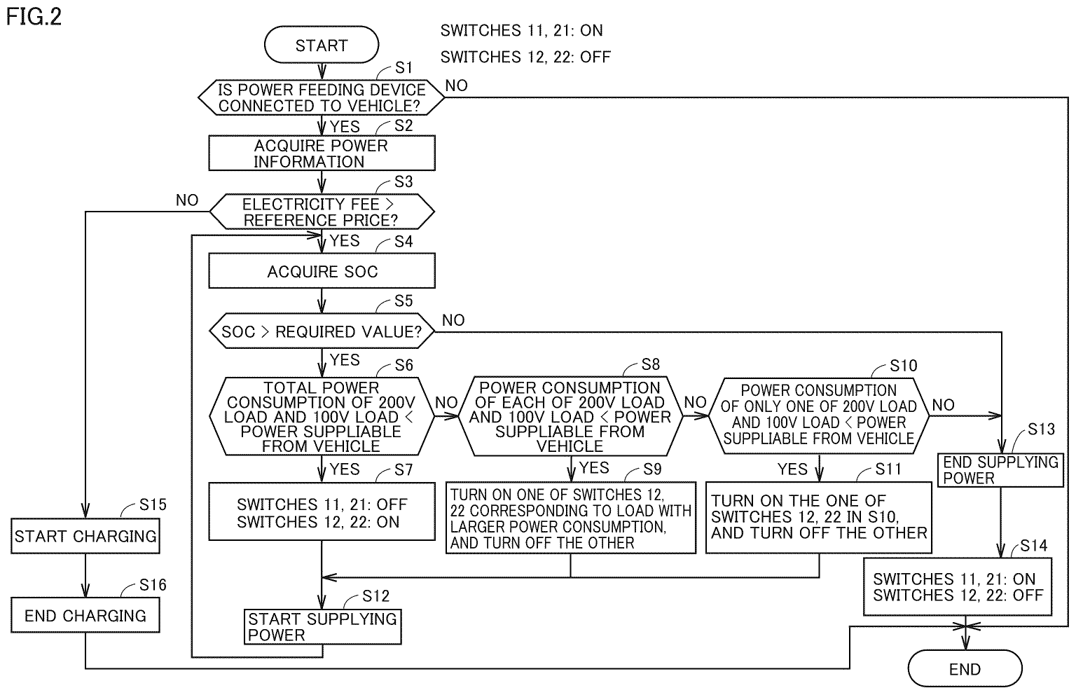

FIG. 2 is a flowchart showing a first example of a processing procedure related to control of the switches 11, 12, 21, and 22. The process shown in this flowchart is executed when a predetermined condition is satisfied (for example, every predetermined cycle). Each step is implemented by software processing by the controller 400 (processor 401), but may be implemented by hardware (electrical circuit) disposed in the controller 400. Hereinafter, the step is abbreviated as S. The same applies to other flowcharts described later.

Here, the power supply system 100 shown in FIG. 1 will be described as an example. At the start of the series of processing, it is assumed that the switches 11 and 12 are turned on (closed) and the switches 12 and 22 are turned off (opened).

Referring to FIGS. 1 and 2, in S1, controller 400 determines whether or not power conversion device 13 is connected to vehicle 300. When the power conversion device 13 is connected to the vehicle 300 (YES in S1), the controller 400 advances the process to S2. When the power conversion device 13 is not connected to the vehicle 300 (NO in S1), the controller 400 ends the process. Note that the process of S1 may be omitted.

In S2, the controller 400 acquires power information (current electricity fee information in this example) of the system power supply 200, for example, from an energy management server (not shown).

In S3, the controller 400 determines whether the current electricity fee obtained in S2 is higher than a reference price (e.g., an average price of electricity fees of the day). When the current electricity fee is higher than the reference price (YES in S3), controller 400 advances the process to S4. When the current electricity fee is equal to or less than the reference price (NO in S3), the controller 400 advances the process to S15. The reference price is an example of the “predetermined threshold value” in the present disclosure.

In S4, the controller 400 acquires a state of charge (SOC) of a battery mounted on the vehicle 300 by communication or the like with the vehicle 300. Then, the controller 400 determines whether or not the SOC acquired in S4 is higher than a required value (S5). The required value is, for example, a value corresponding to the amount of electric power necessary for traveling of the vehicle 300 on the next day. The required value may be a fixed value determined in advance, or may be a variable value determined according to the actual use result of the vehicle 300.

If the SOC is higher than the required value (YES in S5), controller 400 advances the process to S6. If the SOC is equal to or less than the required value (NO in S5), the controller 400 advances the process to S13.

In S6, the controller 400 determines whether or not the total value of the power consumptions of the load 7 and the load 8 is less than the power that can be supplied from the vehicle 300 (the upper limit of the power to be supplied/hereinafter, referred to as the power supply capability). The power consumption of the load 7 (8) means power (demand power) required to supply power to the load 7 (8). When the total value is less than the power supply capability of vehicle 300 (YES in S6), controller 400 advances the process to S7. When the total value is equal to or greater than the power supply capability of vehicle 300 (NO in S6), controller 400 advances the process to S8.

For example, when the power supply capability of the vehicle 300 is 6 kW, the power consumption of the load 7 is 3 KW, and the power consumption of the load 8 is 2 kW, the controller 400 advances the process to S7. If the power supply capability of the vehicle 300 is 6 kW, the power consumption of the load 7 is 3 kW, and the power consumption of the load 8 is 4 kW, the controller 400 advances the process to S8.

In S7, the controller 400 turns off each of the switches 11 and 21 and turns on each of the switches 12 and 22. Accordingly, the power supply from the system power supply 200 to the loads 7 and 8 is stopped, and the power supply from the vehicle 300 to the loads 7 and 8 is enabled. As a result, the power demand of each of the load 7 and the load 8 can be satisfied by the power supplied from the vehicle 300. Next, the controller 400 advances the process to S12.

In S8, the controller 400 determines whether the power consumption of each of the load 7 and the load 8 is less than the power supply capability of the vehicle 300. When the power consumption of each of load 7 and load 8 is less than the power supply capability of vehicle 300 (YES in S8), controller 400 advances the process to S9. When the power consumption of at least one of load 7 and load 8 is equal to or higher than the power supply capability of vehicle 300 (NO in S8), controller 400 advances the process to S10.

For example, when the power supply capability of the vehicle 300 is 6 kW, the power consumption of the load 7 is 3 kW, and the power consumption of the load 8 is 4 kW, the controller 400 advances the process to S9. If the power supply capability of the vehicle 300 is 6 kW, the power consumption of the load 7 is 3 KW, and the power consumption of the load 8 is 7 KW, the controller 400 advances the process to S10. If the power supply capability of the vehicle 300 is 6 KW, the power consumption of the load 7 is 7 KW, and the power consumption of the load 8 is 7 KW, the controller 400 advances the process to S10.

In S9, the controller 400 turns on one of the switches 12 and 22 corresponding to a load with a larger power consumption and turns off the other. For example, when the power supply capability of the vehicle 300 is 6 kW, the power consumption of the load 7 is 3 kW, and the power consumption of the load 8 is 4 KW, the controller 400 turns on the switch 22 corresponding to the load 8 and turns off the switch 12 corresponding to the load 7. Therefore, only one of the loads 7 and 8 that consumes a larger amount of power is supplied with power from the vehicle 300.

Thus, when the electricity fee is relatively high, power can be supplied from the vehicle 300 to one of the load 7 and the load 8 that consumes more power. As a result, since it is possible to effectively reduce the amount of power supplied from the system power supply 200 of high electricity fee, it is possible to easily reduce the electricity fee. When the power consumption of the load 7 is equal to the power consumption of the load 8, only one of the switch 12 and the switch 22 selected at random may be turned on.

At this time, the load with lower power consumption may be supplied with power from the system power supply 200. Next, the controller 400 advances the process to S12.

In S10, the controller 400 determines whether or not only one of the power consumption of the load 7 and the power consumption of the load 8 is less than the power supply capability of the vehicle 300. When only one of the power consumption of load 7 and the power consumption of load 8 is less than the power supply capability of vehicle 300 (YES in S10), controller 400 advances the process to S11. When the power consumption of both load 7 and load 8 is equal to or higher than the power supply capability of vehicle 300 (NO in S10), controller 400 advances the process to S13.

For example, when the power supply capability of the vehicle 300 is 6 kW, the power consumption of the load 7 is 3 KW, and the power consumption of the load 8 is 7 kW, the controller 400 advances the process to S11. If the power supply capability of the vehicle 300 is 6 KW, the power consumption of the load 7 is 7 kW, and the power consumption of the load 8 is 7 KW, the controller 400 advances the process to S13.

In S11, the controller 400 turns on the switch corresponding to the load having power consumption less than the power to be supplied from the vehicle 300 among the switches 12 and 22, and turns off the other. For example, when the power supply capability of the vehicle 300 is 6 kW, the power consumption of the load 7 is 3 KW, and the power consumption of the load 8 is 7 KW, the controller 400 turns on the switch 12 corresponding to the load 7 and turns off the switch 22 corresponding to the load 8. At this time, a load whose power consumption is equal to or higher than the power supply capability of the vehicle 300 may be supplied with power from the system power supply 200. Next, the controller 400 advances the process to S12.

Although an example in which the process of S10 is performed after the process of S8 is described above, the process of S10 may be performed before the process of S8.

In S12, the controller 400 starts power supply control from the vehicle 300 to the load 7 and/or the load 8. When the power supply control has already been started, the controller 400 continues the power supply control. Next, the controller 400 returns the process to S4.

In S13, the controller 400 ends the power supply control from the vehicle 300 to the load 7 and/or the load 8. Next, the controller 400 advances the process to S14.

In S14, the controller 400 turns on each of the switches 11 and 21 and turns off each of the switches 12 and 22. After that, the controller 400 ends the series of processing flows.

In S15, the controller 400 controls power supply from the system power supply 200 to each of the load 7 and the load 8 via the switches 11 and 12. Next, the controller 400 advances the process to S16.

In S16, the controller 400 ends the power supply control from the system power supply 200 to each of the load 7 and the load 8. After that, the controller 400 ends the series of processing flows.

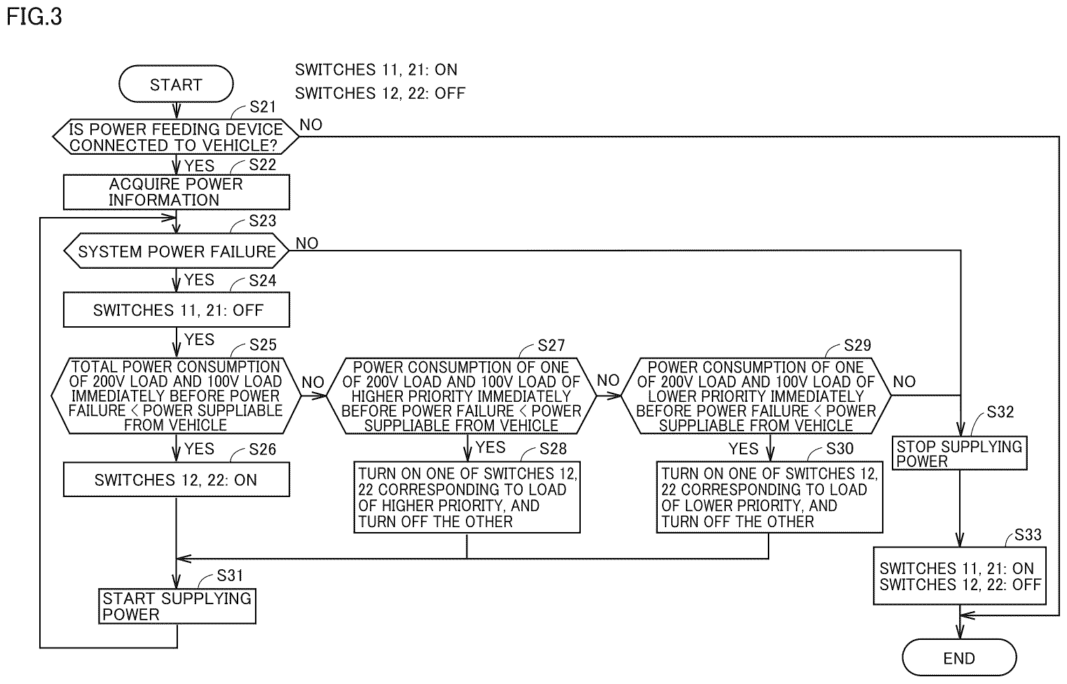

FIG. 3 is a flowchart showing a second example of a processing procedure related to control of the switches 11, 12, 21, and 22. The process shown in this flowchart is executed when a predetermined condition is satisfied (for example, every predetermined cycle).

Here, the power supply system 100 shown in FIG. 1 will be described as an example. At the start of the series of processing, it is assumed that the switches 11 and 12 are turned on (closed) and the switches 12 and 22 are turned off (opened). In the present embodiment, the priority of the load to which power is supplied by the power of the vehicle 300 when a power failure of the system power supply 200 occurs is set in advance. For example, the priority of the load 8 is set higher than the priority of the load 7.

Referring to FIGS. 1 and 3, in S21, controller 400 determines whether or not power conversion device 13 is connected to vehicle 300. When power conversion device 13 is connected to vehicle 300 (YES in S21), controller 400 advances the process to S22. When power conversion device 13 is not connected to vehicle 300 (NO in S21), controller 400 ends the process. Note that the process of S21 may be omitted.

In S22, the controller 400 acquires the power information of the system power supply 200 (in this example, the power supply state of the system power supply 200) from, for example, an energy management server (not shown).

In S23, the controller 400 determines whether a power failure of the system power supply 200 occurs based on the information acquired in S22. If a power failure of the system power supply 200 occurs (YES in S23), controller 400 advances the process to S24. If a power failure of the system power supply 200 does not occur (NO in S23), controller 400 advances the process to S32.

In S24, the controller 400 turns off each of the switches 11 and 21 corresponding to the system power supply 200. Next, the controller 400 advances the process to S25.

In S25, the controller 400 determines whether or not the total value of the power consumptions of the load 7 and the load 8 immediately before the power failure is less than the power supply capability of the vehicle 300. When the total value immediately before the power failure is less than the power supply capability of vehicle 300 (YES in S25), controller 400 advances the process to S26. When the total value is equal to or greater than the power supply capability of vehicle 300 (NO in S25), controller 400 advances the process to S27. Note that the information on the power consumption of the load 7 and the load 8 for each time may be stored in the memory 402 of the controller 400.

In S26, the controller 400 turns on each of the switches 12 and 22. Accordingly, power can be supplied from the vehicle 300 to the loads 7 and 8. Next, the controller 400 advances the process to S31.

In S27, the controller 400 determines whether or not the power consumption immediately before the power failure of the load 7 or the load 8 having the higher priority is less than the power supply capability of the vehicle 300. When the power consumption of the load with the high priority is less than the power supply capability of vehicle 300 (YES in S27), controller 400 advances the process to S28. When the power consumption of the load having the higher priority is equal to or higher than the power supply capability of vehicle 300 (NO in S27), controller 400 advances the process to S29.

In S28, the controller 400 turns on the switch corresponding to the higher priority load among the switch 12 and the switch 22, and turns off the other switch. For example, when the priority of the load 8 is higher than that of the load 7, if the power supply capability of the vehicle 300 is 6 kW and the power consumption of the load 8 is 3 KW, the controller 400 turns on the switch 22 corresponding to the load 8 and turns off the switch 12 corresponding to the load 7. Next, the controller 400 advances the process to S31.

As a result, when the power failure of the system power supply 200 occurs, the operation of the load 7 or the load 8 having a higher priority (importance) can be restored more quickly by using the power from the vehicle 300.

In S29, the controller 400 determines whether the power consumption immediately before the power failure of the load 7 or the load 8 having the lower priority is less than the power supply capability of the vehicle 300. When the power consumption of the load having the lower priority is less than the power supply capability of vehicle 300 (YES in S29), controller 400 advances the process to S30. When the power consumption of the load having the lower priority is equal to or higher than the power supply capability of vehicle 300 (NO in S29), controller 400 causes the process to proceed to S32.

Although an example in which the process of S29 is performed after the process of S27 is described above, the process of S29 may be performed before the process of S27.

In S31, the controller 400 starts power supply control from the vehicle 300 to the load 7 and/or the load 8. When the power supply control has already been started, the controller 400 continues the power supply control. Next, the controller 400 returns the process to S23.

In S32, the controller 400 ends the power supply control from the vehicle 300 to the load 7 and/or the load 8. Next, the controller 400 advances the process to S33.

In S33, the controller 400 turns on each of the switches 11 and 21 and turns off each of the switches 12 and 22. After that, the controller 400 ends the series of processing flows.

As described above, in the present embodiment, when power is supplied from the vehicle 300 to the loads 7 and 8, the controller 400 executes the switching process of switching on and off the switch 12 and the switch 22 based on the power supply capability of the vehicle 300 and the power demand of the load 7 and the power demand of the load 8. Accordingly, it is possible to appropriately adjust the power to be supplied to the load 7 and the power to be supplied to the load 8 based on the power supply capability of the vehicle 300, the power demand of the load 7, and the power demand of the load 8. Therefore, the power supplied from the vehicle 300 can be appropriately distributed to the load 7 and the load 8.

### Modification

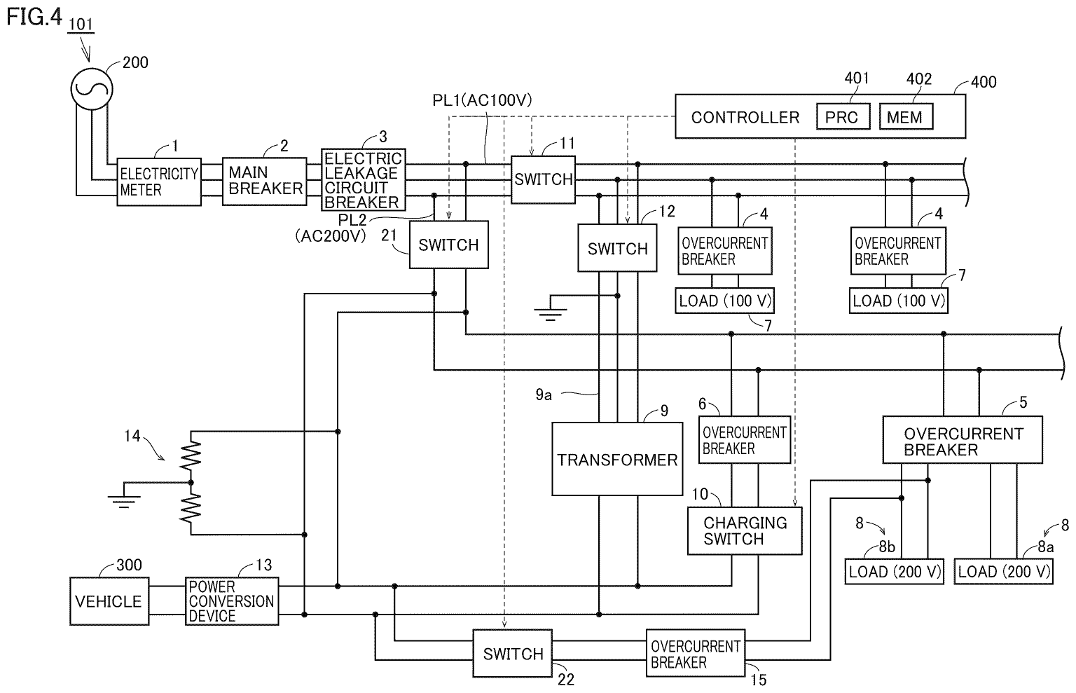

In the above embodiment, an example has been described in which power is supplied to all the devices of the load 8 when power is supplied from the vehicle 300 to, for example, the load 8, but the present disclosure is not limited thereto. Power may be supplied to some devices of the load 8. Although the load 8 is given as an example, power may be supplied to some devices of the load 7 instead of or in addition to the load 8. FIG. 4 illustrates an example in which power is supplied from the vehicle 300 to a part of the load 8. In the example illustrated in FIG. 4, the priority of the load 8 may be higher than the priority of the load 7.

The power supply system 101 shown in FIG. 4 includes an overcurrent breaker 15. In the example illustrated in FIG. 4, the load 8 includes a load 8a and a load 8b. The load 8b is a load having a particularly high priority among the loads 8. The load 8b may be selected such that the total amount of power consumption of the load 8b is equal to or less than the power supply capability of the vehicle 300.

A first end of the overcurrent breaker 15 is electrically connected to the switch 22. The second end of the overcurrent breaker 15 is electrically connected to the load 8b. Each of the load 8a and the load 8b is electrically connected to the overcurrent breaker 5.

In the configuration shown in FIG. 4, in each determination shown in FIG. 3, the power consumption of the load 8b instead of the power consumption of the load 8 serves as a reference for determination. Accordingly, it is possible to more reliably supply power from the vehicle 300 to the load 8b having a particularly high priority among the loads 8 having a relatively high priority. Note that, in each determination shown in FIG. 2, the power consumption of the load 8b may be used as a reference for determination instead of the power consumption of the load 8. The priority of the load 8 may be lower than the priority of the load 7.

Although the transformer 9 is electrically connected to the switch 12 on the load 7 side in the above embodiment, the present disclosure is not limited thereto. A transformer electrically connected to the switch 22 on the load 8 side may be disposed instead of or in addition to the transformer 9.

In the above embodiment, an example has been described in which the power supply from the vehicle 300 to the load is performed based on the priority of the load when the power failure of the system power supply 200 occurs, but the present disclosure is not limited thereto. Each determination illustrated in FIG. 2 may be performed even when the power failure of the system power supply 200 occurs. In addition, even in a case where the power failure of the system power supply 200 does not occur, the determination may be made based on the priority in the same manner as each determination illustrated in FIG. 3.

Although the current circuit breaker 120 includes the main breaker 2 and the electric leakage circuit breaker 3 in the above embodiment, the present disclosure is not limited thereto. The current circuit breaker may include only one of the main breaker 2 and the electric leakage circuit breaker 3.

In the above embodiment, an example in which the controller 400 can execute each of the processing flows of FIGS. 2 and 3 has been described, but the present disclosure is not limited thereto. The controller may be capable of executing only one of the processing flows of FIGS. 2 and 3.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power supply system that supplies AC power from a system power supply to an electrical load of a house, the power supply system comprising:
a current circuit breaker that receives AC power supplied from the system power supply to the house, and interrupts the AC power when at least one of electric leakage and overcurrent occurs;
a load circuit breaker that electrically disconnects the current circuit breaker and the electrical load from each other;
a power conversion device that supplies AC power from a vehicle to the electrical load when the vehicle is connected to the power conversion device;
a switch that is capable of switching between electrical connection and disconnection between the load circuit breaker and the power conversion device; and
a switching device that turns the switch on or off, wherein
the electrical load includes:
a first load that is operated by a first voltage; and
a second load that is operated by a second voltage different from the first voltage,
the switch includes:
a first switch capable of switching between electrical connection and disconnection between the first load and the power conversion device; and
a second switch capable of switching between electrical connection and disconnection between the second load and the power conversion device, and
for supplying electric power from the vehicle to the electrical load, the switching device turns on or off each of the first switch and the second switch, based on a power supply capability of the vehicle, and a power demand of the first load and a power demand of the second load.

2. The power supply system according to claim 1, wherein
when a total of a power consumption of the first load and a power consumption of the second load is less than an upper limit of power to be supplied from the vehicle, the switching device electrically connects each of the first load and the second load to the power conversion device.

3. The power supply system according to claim 2, wherein
when
the total is more than or equal to the upper limit of the power to be supplied,
each of the power consumption of the first load and the power consumption of the second load is less than the upper limit of the power to be supplied, and
a current electricity fee is higher than a predetermined threshold value,
the switching device electrically connects, to the power conversion device, one of the first load and the second load that consumes more power, and electrically disconnects, from the power conversion device, the other of the first load and the second load that consumes less power.

4. The power supply system according to claim 2, wherein
the first load and the second load are assigned respective priorities different from each other, and
when
the total is more than or equal to the upper limit of the power to be supplied,
the power consumption of one of the first load and the second load that is assigned a higher priority is less than the upper limit of the power to be supplied, and
a power failure of the system power supply occurs,
the switching device electrically connects, to the power conversion device, the one of the first load and the second load that is assigned the higher priority, and electrically disconnect, from the power conversion device, the other of the first load and the second load that is assigned a lower priority.

5. The power supply system according to claim 1, further comprising a transformer that transforms the second voltage into the first voltage, wherein
an output voltage of the vehicle is the second voltage when supplying electric power, and
the transformer is located in a current path between the first switch and the power conversion device.
